(19) United States
(12) Patent Application Publication
(10) Pub. No.: US 2023/0098838 A1
(43) Pub. Date: Mar. 30, 2023

(54) METHOD AND DEVICE FOR DECORATING AN INJECTION-MOLDED PART, AND INJECTION MOLDED-PART

(71) Applicant: LEONHARD KURZ Stifting & Co. KG, Fürth (DE)

(72) Inventors: Harald Burger, Nürnberg (DE); Gerald Golling, Oberasbach (DE)

(21) Appl. No.: 17/802,643

(22) PCT Filed: Feb. 8, 2021
(86) PCT No.: PCT/EP2021/052912

§ 371 Date: Aug. 26, 2022

(30) Foreign Application Priority Data
Feb. 28, 2020 (DE) 10 2020 105 361.4

(51) Int. Cl. B29C 45/14

(52) U.S. Cl. CPC B29C 45/14827; B29C 45/14008; B29C 2045/1404; B29C 2045/14049; B29C 2045/14155

(57) ABSTRACT

A method and a device (20) for decorating an injection-molded part (40), and an injection-molded part (40). The method for decorating an injection-molded part (40) includes the following steps, which are in particular carried out in the following order:
a) providing a transfer film in the form of a roll (10)
b) cutting the transfer film to size to form at least one label (30, 11)
c) laying the at least one label (30) in an injection-molding apparatus (21) by means of a robot arm (24, 12)
d) closing the injection-molding apparatus (21, 13)
e) back-injection molding the at least one label (30) by means of an injection-molding compound (14)
f) opening the injection-molding apparatus (21) and removing the injection-molded part (40, 15).

The invention relates to a method and a device for decorating an injection-molded part, and to an injection-molded part.

It is known to stamp or coat a transfer ply of a hot-stamping film onto a body for decoration. As described for example in DE 102012109315 A1, such a stamping device has a retaining apparatus, in which the workpiece to be stamped or coated is clamped, as stamping receiver. Further, a stamping die is provided, which presses a hot-stamping film against the surfaces of the workpiece to be decorated, wherein the stamping pressure here is built up between stamping receiver and stamping die.

The object is therefore to specify an improved method and an improved device for decorating an injection-molded part, and an improved injection-molded part.

This object is achieved by a method for decorating an injection-molded part comprising the following steps, which are in particular carried out in the following order:
a) providing a transfer film in the form of a roll
b) cutting the transfer film to size to form at least one label
c) laying the at least one label in an injection-molding apparatus by means of a robot arm
d) closing the injection-molding apparatus
e) back-injection molding the at least one label by means of an injection-molding compound
f) opening the injection-molding apparatus and removing the at least one injection-molded part

This object is further achieved by a device for decorating an injection-molded part, wherein the device has at least one cutting device for cutting at least one label to size out of a transfer film, at least one robot arm and at least one injection-molding apparatus, wherein the at least one label is laid in the injection-molding apparatus by means of the at least one robot arm and the at least one label is joined to an injection-molding compound in the injection-molding apparatus in order to produce at least one injection-molded part.

Further, this object is achieved by an injection-molded part, wherein the injection-molded part has at least one injection-molded body and at least one label, in particular a transfer ply, joined to the at least one injection-molded body.

Through the invention, it is now possible to improve the decoration of an injection-molded part and in particular to increase the variety of functions and/or the variety of designs. Through the use of an individualized label, in particular comprising a transfer film, a position-accurate or positionally accurate decoration of an injection-molded part can be effected in a simple manner. Further, the advantage results that when an individualized label, consisting of a transfer film, is used the carrier film initially remains on the injection-molded part after the injection molding and thus at the same time functions as a protective layer, in particular when the injection-molded part is removed and/or when the injection-molded part is transported. The carrier film can be taken off for example only shortly before or after further processing, in particular an installation or another assembly of the injection-molded part. Because the carrier film acts as a protective layer of the injection-molded part, waste can thus also be reduced, as possible damage of the transfer ply is counteracted by the carrier film.

Further, it has been shown that, by means of the method according to the invention, sensitive layers of the transfer ply, which have for example optically active, in particular optically variable, layers, conductive tracks, electrical functional layers or metallizations, are additionally protected by the carrier film.

It is preferably possible for the transfer film to have at least one carrier film and at least one transfer ply.

It can also be provided that at least one detachment layer is arranged between the at least one carrier film and the at least one transfer ply.

It is preferably provided that the at least one detachment layer comprises at least one material or a combination of materials selected from: wax, carnauba wax, montanic acid ester, polyethylene wax, polyamide wax, PTFE wax, silicone, melamine formaldehyde resin.

In an advantageous embodiment, it can be provided that the at least one detachment layer has a layer thickness smaller than 1 μm, in particular smaller than 0.5 μm.

The at least one detachment layer is preferably a polymeric detachment layer, which has a detachment behavior that is better than and/or different from conventional carrier films. Such detachment layers are irreversibly joined to the carrier film and a transfer ply is arranged on the detachment layer. The transfer ply can in particular be detached from the carrier film more easily with a polymeric detachment layer, with the result that a higher-quality decoration of the injection-molded part is achieved.

The at least one transfer ply can be formed as a multilayer body formed of several layers. In particular, it is provided that the at least one transfer ply has at least one layer or a combination of layers selected from: adhesive layer, detachment layer, decorative layer, metal layer, semiconductor layer, carbon black layer, adhesion-promoting layer, primer layer, color layer, protective layer, functional layer.

The protective layer can be formed as a protective varnish made of a PMMA-based varnish with preferably a layer thickness in the range of from 0.5 μm to 5 μm, in particular in the range of from 2 μm to 4 μm. Through the choice of such a layer thickness, it is ensured that, on the one hand, a corresponding protection is provided and, on the other hand, the further processability of the transfer film is provided, and no delamination on the boundary surface of the protective varnish layer and the other layers of the transfer ply or the decorative layer results. Further, this also improves the resistance of the decorated injection-molded part to mechanical and/or physical and/or chemical environmental influences.

The protective varnish can also consist of a radiation-curing dual-cure varnish. This dual-cure varnish can be thermally pre-crosslinked in a first step during and/or after application in liquid form and can be radically post-crosslinked in a second step after the processing of the transfer film, in particular via high-energy radiation, preferably UV radiation. Dual-cure varnishes of this type can consist of different polymers or oligomers, which have unsaturated acrylate or methacrylate groups. These functional groups can be radically crosslinked with each other in the above-named second step. For the thermal pre-crosslinking in the first step, at least two or more alcohol groups must also be present in the case of these polymers or oligomers. These alcohol groups can be crosslinked with multifunctional isocyanates or melamine formaldehyde resins. Various UV raw materials such as epoxy acrylates, polyether acrylates, polyester acrylates and in particular acrylate acrylates come into consideration as unsaturated polymers or oligomers. Both blocked and unblocked representatives based on TDI (TDI=toluene-2,4-diisocyanate), HDI (HDI=hexamethylene diisocyanate) or IPDI (IPDI=isophorone diisocyanate) come into consideration as isocyanate. The melamine crosslinkers can be fully etherified versions, can be imino types or represent benzoguanamine representatives.

It can also be provided that the protective layer is formed as a protective varnish made of a varnish based on PMMA (PMMA=polymethyl methacrylate) or a varnish based on a mixture of PVDF (PVDF=polyvinylidene fluoride) and PMMA, with preferably a layer thickness in the range of from 2 μm to 50 μm, preferably in the range of from 5 μm to 30 μm. These varnishes bring the mechanical brittleness needed for a transfer film and for being able to sufficiently accurately stamp it out, e.g. separate it, at the desired outer limits of the transferred areas of surface of the transfer plies.

The decorative layer can be formed as a or single-layered or multi-layered decorative layer. This decorative layer preferably comprises one or more layers.

The decorative layer can preferably have one or more color layers, in particular colored varnish layers. These color layers can in each case be dyed differently and/or can be formed transparent and/or opaque and can also be separated by one or more further layers, in particular transparent layers. The color layers can in each case be present over the whole surface or only partially in their layer plane. The color layers are preferably applied by means of known printing methods selected from: gravure printing, screen printing, offset printing, inkjet printing, pad printing, xerographic printing or combinations thereof. The color layers can here consist of a binder and colorant and/or fillers and/or pigments, in particular also optically variable pigments and/or interference layer pigments and/or liquid-crystal pigments and/or magnetically orientable pigments and/or thermochromic pigments and/or metallic pigments. Further, the color layer can also have phosphorescent and/or luminescent dyes.

Further, the decorative layer can also comprise one or more reflective layers, which are preferably formed opaque, translucent and/or partial. In particular, the reflective layers can consist of metals and/or HRI layers (HRI=High Refractive Index), thus layers with a high refractive index, in particular with a refractive index greater than 1.5. For example aluminum, tin, indium, chromium or copper or alloys thereof come into consideration as metals. For example ZnS or SiO₂ come into consideration as HRI layers.

Further, the decorative layer can also have one or more optically active relief structures, in particular diffractive structures and/or holograms and/or refractive structures and/or matte structures. At least one reflective layer is arranged directly on the relief structure at least in areas.

In the case of a metal layer, it is advantageous to apply this metal layer by vapor deposition, physical vapor deposition (PVD) and/or chemical vapor deposition (CVD) and/or sputtering. Different decorative layers can also consist of different metals and in particular differently colored metals.

Metal layers are preferably applied to a clear varnish layer or to a pigment-containing varnish layer. It is then advantageous to apply an additional varnish layer to the metal layer as a metal adhesion-promoting layer in order to improve the adhesion of layers being built up thereon.

The layers of the transfer ply, in particular of the decorative layer, can be present in each case over the whole surface or in each case only partially. If several layers of the transfer ply, in particular decorative layers, are present in each case partially, individual elements in the layers of the transfer ply can be arranged next to each other, in particular immediately next to each other, or overlapping at least in areas. It is also possible for a partial layer of the transfer ply to be arranged on a whole-surface layer of the transfer ply, wherein the whole-surface layer of the transfer ply serves as a background or substrate for the partial layer of the transfer ply, which in particular forms a contrast to the partial layer of the transfer ply in terms of color and/or in terms of the brightness and/or reflectivity and/or roughness.

It is also possible for the injection-molded part to form a part of the resulting decoration, by combining the color and/or the brightness and/or the reflectivity and/or the roughness of the injection-molded part with the layers arranged thereon of the transfer ply, in particular decorative layers. The injection-molded part can be transparent or translucent or opaque and/or have a coloring with dyes and/or pigments. In particular, the injection-molded part forms a background or substrate for the layers of the transfer ply, in particular decorative layers, which preferably forms a contrast to the layers of the transfer ply, in particular decorative layers, in terms of color and/or in terms of the brightness and/or reflectivity and/or roughness.

In a top view of the transfer ply, the elements of the layers of the transfer ply can be offset with respect to each other or else also be arranged overlapping. In a top view of the transfer ply, however, the elements can also be arranged next to each other.

The elements, in particular the decorative layer, can also form one or more motifs. A motif can be, for example, a graphically represented outline, a figural representation, an image, a visually recognizable design element, a symbol, a logo, a portrait, a pattern, an endless pattern, an alphanumeric character, a coding, a code pattern, a cryptographic pattern, a text, a color design and the like. The motif can also be formed individualized.

By individualized is meant in particular that the print comprises items of information which are individually unique to each individual print, such as for example unique serial numbers. By individualized is in particular also meant that the print comprises items of information which are identical for a group of prints, but are in each case unique to each group of prints, for example a batch number. In the following, when the term print is used, an individualized print or also a non-individualized print can be meant by this.

Advantageously, the elements of the layers of the transfer ply are arranged such that, in a top view of the transfer ply, at least some of the elements or parts of some elements form an overall motif. One or more of these elements can be individualized or also non-individualized. For example, one or more non-individualized elements can be complemented with one or more individualized elements to form an overall motif. In particular, the prints can be arranged in register with each other.

By register or registration, or register accuracy or registration accuracy, is meant a positional accuracy of two or more elements and/or layers relative to each other. The register accuracy is to vary within a predefined tolerance, which is to be as small as possible. At the same time, the register accuracy of several elements and/or layers relative to each other is an important feature in order to increase the process reliability. The positionally accurate positioning can be effected in particular by means of sensory, preferably optically detectable registration marks or register marks. These registration marks or register marks can either represent specific separate elements or areas or layers or themselves be part of the elements or areas or layers to be positioned.

It can also be provided that one or more transparent or translucent or transparently or translucently dyed spacer layers with a thickness of from for example 0.5 μm to 10 μm are arranged between two partial layers of the transfer ply, in particular decorative layers, with elements or decorative elements or between a partial layer of the transfer ply, in particular decorative layer, with elements or decorative elements and a whole-surface layer of the transfer ply, in particular decorative layer, in order to generate a three-dimensional depth effect of the decoration. It is also possible for the at least one injection-molded part to represent such a spacer layer or to perform the function of such a spacer layer.

In particular, shading and/or concealing effects of the elements or decorative elements can be achieved, in particular depending on the angle of illumination and/or angle of observation of the decorative layers.

In the case of a varnish layer with a molded surface relief, it is advantageous to use an optically active surface relief as surface relief. The surface relief can be a surface relief which forms a ray-optically active and thus refractively acting structure and thus generates in particular a macroscopic optically and/or haptically detectable motif. Further, it is also possible for the surface relief to be a matte structure which generates, for example, the optical impression of a matted metallic surface in combination with a corresponding metal layer in the decorative layer structure.

Further, it is also possible for the surface relief to be a surface relief which forms lens structures and/or microlens structures and/or freeform surface structures which further optionally convey a three-dimensional impression of a motif. Further, it is also possible for diffractively acting structures to be used as surface relief, for example holograms or the like. However, it is also possible for the molded surface relief to be a merely tactilely detectable surface relief which for example simulates a wood decoration or the like.

It is preferably provided that the at least one color layer is formed of a PMMA-based varnish with preferably a layer thickness in the range of from 0.5 μm to 10 μm.

Preferably, it is provided that the primer has an adhesive layer and/or adhesion-promoting layer. It can provided that the primer layer is formed with a layer thickness in the range of from 1 μm to 5 μm. Materials coming into consideration for the primer are PMMA, PVC, polyester, polyurethanes, chlorinated polyolefins, polypropylene, epoxy resins or polyurethane-polyols in combination with inactivated isocyanates. The primer layer can moreover contain inorganic fillers. The primer layer is preferably made of PVC for the use of the transfer film in insert molding or in-mold decoration.

It is preferably provided that the functional layer is an electrical functional layer, for example in the form of capacitive elements for providing a touchpad functionality, with the result that the electrical functional layer is a sensor. It is alternatively or additionally possible for the electrical functional layer to carry at least one light-emitting diode element, e.g. organic light-emitting diodes (“OLEDs”). It is also possible in particular for the electrical functional layer to have a touch function and/or an RFID function.

Furthermore, it is preferably provided that the functional layer has a contacting area, preferably in a first zone. It is also possible for an electrical connection for the elements to be provided and to have a contact reinforcement in the functional layer, in particular electrical functional layer, in the first zone. The contact reinforcement has the function of making a contacting of this connection element with a counter contact easier. By the term “zone” is meant here a defined surface area which is occupied by the label or a layer of the label, wherein the surface area lies in a plane formed in the case of a top view of the label. For example, the first zone can completely occupy or only partially occupy the entire surface area of the label.

Various designs which generate a particularly high-quality optical impression can be realized by a functional layer. It is also possible to design the functional layer as a display and/or touchscreen.

The functional layer can preferably also have a soft-touch surface and/or an anti-slip coating.

The transfer film, in particular the transfer ply, preferably has an individual image and/or an endless pattern. It can also be provided that the transfer film, in particular the transfer ply, forms a monochromatic surface area. It can also be provided that the transfer film, in particular the transfer ply, forms a transparent or translucent surface area without an optically recognizable individual image and/or endless pattern.

In particular, the transfer film, in particular the transfer ply, has areas which are metallized and/or structured and/or brushed and/or provided with other surface structures and which transfer a structure into the surface of the injection-molded part during the back-injection molding, in particular the injection molding. Thus, it is possible for example to mold a soft-touch surface or a relief structure into the injection-molded part.

In particular, it is provided that the transfer film, in particular the at least one carrier film and/or the at least one transfer ply, is biodegradable and/or compostable.

Biodegradable means here that a material breaks down into water and/or carbon dioxide and/or biomass to the extent of more than 90%, in particular to the extent of more than 95%, after a predefined time under defined temperature, air and moisture conditions in the presence of microorganisms or fungi. Biodegradable and/or compostable materials preferably comprise a material and/or a combination of materials selected from: starch, starch derivatives, cellulose, cellulose derivatives, lignin, polylactide (PLA), polyhydroxy fatty acids (PHB and/or PHV), chitin, chitosan, proteins, casein, gelatin, degradable polyester (PE).

It is also possible for the at least one carrier film to comprise a material or a combination of materials selected from: PET, PMMA, PC, PE, PVC, ABS, PU, PBS, TPU, PP, PLA, PEF and/or PAN.

Further, it is also preferably provided that at least one registration mark and/or at least one register mark and/or at least one motif, which is detectable by means of at least one sensor, in particular optical sensor and/or camera, is applied to the transfer film, in particular to the at least one label, in particular is applied by means of digital printing and/or inkjet printing and/or pad printing.

Further, it is possible in particular for an accuracy in the range of from −0.3 mm to 0.3 mm, preferably from −0.2 mm to 0.2 mm, to be achieved during the production of the transfer film or the transfer plies. In particular, the at least one registration mark and/or register mark which is printed on the transfer film has such an accuracy. By accuracy is meant here the deviation between the target value and the actual value.

It is possible for the at least one robot arm to have at least one suction tool for gripping or picking up the at least one label, in particular by means of vacuum. In particular, it is provided that the robot arm can be moved between the individual stations. For example, the robot arm picks up a label from a magazine in which several labels are collected, in particular are stacked one on top of another, and places it in a pre-centering device. After the centering process, the robot picks up the label from the pre-centering device again and lays the label in the injection-molding apparatus in a positionally accurate manner. It is also conceivable that the removal of the injection-molded part is effected by means of the robot arm.

It is preferably provided that the at least one suction tool has at least one centering device, in particular wherein the at least one centering device has at least two positioning elements, in particular conical positioning elements or truncated cones, and/or at least one flat centering device, which mechanically center the at least one label.

By flat centering device is meant a positively circumferential contour ridge which has the same contour as the label. If conical positioning elements or truncated cones are used, the dimensions of the depression in which the label is positioned are reduced. The label can then preferably fall into the depression along at least one contour of the at least one conical positioning element or truncated cone, and thus centers itself.

It is preferably provided that the injection-molding apparatus, in particular the first injection mold half, has a matching, in particular negative, mating part or copy of the centering device of the suction tool. Thus, a positionally accurate laying of the label in the injection-molding apparatus can be ensured.

It is preferably also provided that the cutting to size of the transfer film to form at least one label in step b) is effected by means of steel strip cutting and/or punching and/or cutting plotters and/or lasers.

In the case of the cutting to size by means of steel strip cutting and/or punching, the contour of the at least one label is in principle punched through extensively in a single vertical lifting movement simultaneously at all points of the at least one label. The simultaneous punching is guaranteed in that the punching tool describes a flat plane or surface area in the lifting direction.

In the case of a cutting plotter, the contour of the at least one label is cut out of the transfer film by means of a rolling knife, which is preferably controllable electronically by means of a program, in particular a CNC program. If the cutting plotter is used, the advantage moreover results that the load on the transfer film, in particular on the transfer ply, is many times smaller than in the case of punching. In addition, a wide variety of contours of the label can be flexibly realized.

If a laser is used to cut the label to size, various contours of the label are likewise realizable, as the laser is preferably controlled electronically by means of a program. For example, it is also possible for holes to be cut out of the label in order to make individual decorations possible. A CO₂ laser is preferably used, which functions contactlessly and thus exerts almost no load on the transfer film, in particular transfer ply. With it, particularly clean cut edges can be realized and thus the quality can be improved and the reject rate reduced.

In an alternative design, it is possible for the cutting to size in step b) to be carried out as an inline cutting to size by means of steel strip cutting and/or punching and/or cutting plotters and/or lasers, wherein small partial areas, in particular a perforation, remain joined to the transfer film, in particular rolled-out transfer film. A possible out-of-place positioning of the contour-cut label is thereby avoided. At the time of the removal of the label, in particular by means of a robot arm or suction tool, the perforation separates and the label can be laid directly in the injection-molding apparatus, in particular in the first injection mold half, without further intermediate steps. Above all, this has advantages when individual-image decorations are used, as an optical positioning of the label is also effected here before the cutting out or punching out, by positioning of the transfer film with reference to X-Y register marks on the film web. The positioning accuracy during the punching out or cutting out is thus also improved. In particular, it is provided that a pre-centering device is not necessary in the case of an inline cutting to size.

If the at least one label is not cut to size inline, it is provided in particular that the at least one label is cut to size immediately before the back-injection molding or before the injection-molding process. Long transport routes and multiple relocations are preferably to be avoided, with the result that no, or only a few, mechanical loads act on the transfer ply and/or the “open” outer contour of the label. By open outer contour is preferably meant the outer edge of the label forming due to the cutting to size of the label.

Further, it is also possible for the cutting to size of the transfer film to form at least one label in step b) to be effected registration-accurately and/or register-accurately, in particular wherein at least one registration mark and/or at least one register mark and/or at least one motif is detected by means of at least one sensor, preferably optical sensor and/or camera.

It is preferred that an accuracy in the range of from −0.1 mm to 0.1 mm, preferably from −0.05 mm to 0.05 mm, is achieved in step b) during the cutting to size of the at least one label.

It is also possible for the following step further to be carried out after step b), in particular before step c):
b1) placing the at least one label in at least one pre-centering device, in particular in at least one magazine for several labels and/or at least in a specific depositing location for an individual label.

It is preferably provided that the following step is further carried out after step b), preferably after step b1), particularly preferably before step c):
b2) picking up the at least one label from the at least one pre-centering device by means of a robot arm, in particular a suction tool, wherein the at least one label is first picked up, is deposited in the at least one pre-centering device again and once more picked up by the robot arm, in particular the suction tool.

The pre-centering device guarantees that the label is always gripped or picked up in a positionally accurate manner and is laid or placed in the injection-molding apparatus in a positionally accurate manner. It is also possible for both a magazine and a further pre-centering device to be used. For example, the magazine is filled with several labels, in particular wherein the labels are stacked one on top of another and thus form a stack, and then a label is picked up from the magazine, in particular from the stack, by means of the robot arm. The label is then preferably laid in the pre-centering device, which positions the label in the pre-centering device mechanically and/or in a self-centering manner. After a predefined period of time, the label is then removed from the pre-centering device again by means of the robot arm. Because the robot arm then arrives at a predefined coordinate and removes the label from the pre-centering device, it is guaranteed that the robot arm or the suction tool always picks up the label in a positionally accurate manner.

In an alternative embodiment, the magazine can itself act as pre-centering device. Here, a label is picked up from the magazine by means of the robot arm and then placed in a corner of the magazine and deposited for a predetermined period of time. Once the predefined period of time has elapsed, the label is again picked up by the robot arm and can then be laid in the injection-molding apparatus, in particular the first injection mold half, in a positionally accurate manner. It is preferably provided that the predefined period of time lies in a range of from 0 s to 10 s, in particular from 0 s to 5 s, preferably from 0 s to 1 s.

In particular, it is provided that the laying-in of the at least one label in step c) is effected in a positionally accurate manner, in particular wherein the centering device, preferably the at least two positioning elements, produces or produce a positive-locking join to the injection-molding apparatus, preferably at least one first injection mold half, particularly preferably at least one rigid or nozzle-side and/or immovable injection mold half. As already stated above, the injection-molding apparatus has a matching or negative mating part of the centering device of the suction tool. It is further also provided that the pre-centering device has a matching or negative mating part of the centering device of the suction tool. Due to such a centering, a centering by means of optical sensors can be dispensed with.

It is preferably possible for the laying-in of the at least one label in step c) to be effected with an accuracy in the range of from −0.2 mm to 0.2 mm, preferably from −0.1 mm to 0.1 mm.

It is also provided in particular that the injection-molding apparatus holds the laid-in at least one label in step c), preferably in step d) and/or step e), by means of vacuum in at least one first injection mold half, in particular the at least one rigid or nozzle-side and/or immovable injection mold half. This has the advantage that the injection-molding apparatus can pick up the at least one label cleanly and hold it in position, without producing wrinkles and/or undefined bends or undulations in the label.

In particular, it is also possible for the injection-molding compound in step e) to be injected by means of injection pressure in the direction of at least one second injection mold half, in particular the movable injection mold half, in particular with the result that the at least one label is pressed against the at least one second injection mold half. The at least one label is advantageously laid in the injection-molding apparatus such that the transfer ply faces the first injection mold half. In particular, it is provided that a firm join between the injection-molding compound and the at least one label is produced in step e). As a result of the injection of the injection-molding compound, the at least one label is pressed with its carrier film against the wall of the second injection mold half, with the result that the carrier film faces the wall of the second injection mold half, in particular rests against the wall of the second injection mold half.

The parameters injection pressure and temperature in step e) during the injection of the injection-molding compound are preferably chosen such that the at least one label, in particular the transfer ply, and the injection-molded part, in particular the injection-molding compound, are firmly joined to each other. A further embodiment of the injection mold halves can additionally include the optimum temperature progression for the method for producing an injection-molded part being supported by a possible variothermal temperature control already integrated in the injection mold halves. It is further advantageous that the optimum temperature progression for the method is supported by a variable temperature control of the injection mold halves.

It is further possible for the time parameter which predominantly results from material properties, temperature and mass ratios of the at least one label and the injection-molding compound as well as the temperature of the injection mold halves to be additionally influenced by a variable temperature control of the injection mold halves. Correlating with these parameters, the time parameter in step e) during the back-injection molding of the at least one label can be chosen such that the at least one label, in particular the transfer ply, firmly joins to the injection-molded part, in particular the injection-molding compound, at least in areas.

Depending on the material of the at least one label used, the parameters time, pressure and temperature can be adapted such that the at least one label firmly joins to the injection-molded part, in particular the injection-molding compound, at least in areas. If reaction adhesives are used as adhesion promoter, the injection-molded part produced with the method is preferably then post-tempered again. As a result of this, the adhesion of the at least one label to the injection-molded part, in particular the injection-molded body or injection-molding compound, is further increased.

The back-injection molding of the at least one label in step e) is preferably effected with a temperature in the range between 200° C. and 320° C., preferably between 240° C. and 290° C., further preferably between 240° C. and 270° C.

The back-injection molding of the at least one label in step e) is advantageously effected with a pressure in the range between 10 bar and 2800 bar, preferably between 500 bar and 2500 bar, further preferably between 500 bar and 2000 bar.

In particular, it is provided that the back-injection molding in step e) is an in-mold decoration (IMD) method and/or an insert-molding method.

It is also possible for the injection-molding apparatus to be opened in step f) after a predetermined time, in particular a predetermined cooling time. The opening after a predetermined time ensures that the join between the label, in particular transfer ply, and the injection-molding compound has a sufficient strength, with the result that the label, in particular the transfer ply, is firmly joined to the injection-molding compound or the injection-molded body.

By the term “firmly joined” is meant here a durable join of two elements, with the result that they no longer separate from each other during normal use of the injection-molded part. Thus, for example, the at least one transfer ply and the injection-molded part, in particular the injection-molded body or injection-molding compound, are firmly joined if there is a mechanically durable join between these two components and the at least one transfer ply cannot be separated from the injection-molded part, in particular the injection-molded body, without damage.

Further, it is possible for the injection-molded part removed in step f), which comprises the injection-molded body including the at least one label arranged thereon, in particular transfer film, preferably transfer ply, to be post-tempered and/or for it to be post-tempered in step e) in the injection mold halves after or during the curing of the injection-molding compound to form an injection-molded body of the injection-molded part, which comprises the cured injection-molded body including the at least one label arranged thereon, in particular transfer film, preferably transfer ply.

As described above, the label is preferably arranged in the injection-molding apparatus such that the carrier film is directed towards the wall of the second injection mold half after the back-injection molding. The carrier film then advantageously forms an outer layer of the injection-molded part. It is preferably possible for the following step further to be carried out after step f):
g) peeling the carrier film off the injection-molded part in order to provide a decorated injection-molded part.

The peeling-off of the carrier film can for example also be peeled off only after transport and/or intermediate storage and/or further processing and/or installation and/or shortly before the first use of the injection-molded part. The carrier film advantageously functions as an additional protective layer, which protects the transfer ply from environmental influences, in particular mechanical and/or physical and/or chemical environmental influences.

After the carrier film has been peeled off, the transfer ply is exposed, with the result that it, in particular in combination with the injection-molded body, provides an optically high-quality decoration and/or functionally high-quality coating.

It is preferably provided that the at least one injection-molding apparatus has at least one first injection mold half, in particular rigid or nozzle-side and/or immovable injection mold half, and at least one second injection mold half, in particular movable injection mold half.

The at least one first injection mold half and/or the at least one second injection mold half preferably has at least one injection channel.

It is further also provided that the two injection mold halves in the closed state form at least one cavity, which substantially corresponds to the shape of the injection-molded part to be produced. The injection-molding compound is preferably injected into the at least one cavity, preferably by means of pressure, via the at least one injection-molding channel. The two injection mold halves advantageously form several cavities, with the result that several injection-molded parts can be provided at the same time. In this case, several labels are laid in the injection-molding apparatus by means of the robot arm. Preferably, exactly one label per cavity is laid in by means of the robot arm.

Further, it is preferably provided that the at least one injection-molding apparatus, in particular the at least one first injection mold half has a negative mold of the at least one centering device, with the result that a positive-locking join to the at least one centering device is effected and a positionally accurate laying-in of the at least one label is made possible, in particular wherein an accuracy in the range of from −0.2 mm to 0.2 mm, preferably from −0.1 mm to 0.1 mm, is achieved.

It is possible for the at least one injection-molding apparatus, in particular the at least one first injection mold half, to have at least one vacuum chamber, which fixes the at least one label after it has been laid in the injection-molding apparatus. Here, it is achieved that the label no longer moves before the injection of the injection-molding compound and thus the registration-accurate and/or positionally accurate arrangement required for the respective use is ensured.

Further, it is also provided that the at least one cutting device comprises at least one punch and/or a cutting plotter and/or a laser.

It is also possible for the at least one cutting device to have at least one sensor, preferably an optical sensor or a camera, which detects an at least one registration mark and/or register mark printed on the transfer film, with the result that the cutting to size of the transfer film to form at least one label is effected in a positionally accurate manner.

It is preferably provided that the at least one cutting device cuts the at least one label to size with an accuracy in the range of from −0.1 mm to 0.1 mm, preferably from −0.05 mm to 0.05 mm.

Furthermore, it is possible for the at least one robot arm to have at least one suction tool for gripping or picking up the at least one label, in particular by means of vacuum. As already described above, the advantage thereby results that the at least one label can thus be picked up free of wrinkles.

It is advantageously provided that the at least one suction tool has a retaining plate, the surface of which substantially corresponds to at least one surface of the at least one first injection mold half and/or the at least one second injection mold half and/or the injection-molded part.

It is also possible for the at least one suction tool to have at least one vacuum zone, in particular circumferential vacuum zone, preferably wherein the vacuum zone is designed in the form of a slit and/or gap running around the retaining plate and/or wherein several slits and/or several gaps are arranged in the retaining plate. The wrinkle-free suction of the label is promoted by such an arrangement. In particular when several slits or vacuum zones are arranged over the entire surface area of the label, air pockets can be effectively avoided.

Further, it is preferably provided that the vacuum zone, in particular the slit and/or gap, has a width and/or depth in the range of from 0.02 mm to 0.2 mm, preferably from 0.05 mm to 0.1 mm.

It is also possible for the vacuum zone to correspond to the contour of the at least one label and/or wherein the dimensions of the vacuum zone, in particular the width and length of the vacuum zone, are smaller than the at least one label, preferably 0.5 mm to 2.0 mm smaller, particularly preferably 0.5 mm to 1.5 mm smaller.

In particular, the contour of the slit and/or the gap of the vacuum zone corresponds to the contour of the at least one label and runs completely within the contour of the at least one label and has a distance from the contour of the at least one label in the range of from 0.5 mm to 2.0 mm, preferably from 0.5 mm to 1.5 mm.

By width and length are meant the dimensions which are spanned by the label in the case of perpendicular observation of the label. By thickness or film thickness, on the other hand, can be meant the depth of the label.

It is preferably also possible for the at least one suction tool, in particular the at least one retaining plate, to have a bend-proof material, in particular aluminum and/or steel and/or magnesium and/or ceramic and/or fiber-reinforced plastic.

Further, it is also preferably provided that the at least one suction tool has at least one centering device, in particular wherein the centering device has at least two positioning elements, in particular conical positioning elements or truncated cones, and/or at least one flat centering device, which center the at least one label mechanically. The centering device produces a positive-locking join at the time when the label is picked up or the label is transferred to the injection-molding tool. A positionally accurate pick-up or transfer is thereby made possible. At the same time, the transfer tolerances are reduced.

In particular, it is provided that the injection-molded part has at least one injection-molded body and at least one label, in particular transfer ply, joined to the at least one injection-molded body.

It is preferably possible for the at least one label, in particular the transfer ply, to be at least partially present in at least one first area and not to be present in at least one second area. It is also possible for the at least one first area and the at least one second area to overlap at least partially. Various decorations can thereby be made possible, which generate a particularly high-quality optical effect and/or a particularly high-quality functional coating. By the term “area” is meant here a defined surface area which is occupied by the label or a layer of the label, wherein the surface area lies in a plane spanned in the case of a top view of the label. For example, the first area and/or second area can completely occupy or only partially occupy the entire surface area of the label.

Advantageously, the injection-molded part, in particular the injection-molded body, and/or the injection-molding compound comprises a plastic material, which comprises a thermoplastic, in particular an impact-resistant thermoplastic. Further, the plastic material consists in particular of polyethylene (PE), polycarbonate (PC), polypropylene (PP), polystyrene (PS), polybutadiene, polynitrile, polyester, polyurethane, polymethacrylate, polyacrylate, polyamide, polyethylene terephthalate (PET), polybutylene terephthalate (PBT), preferably acrylonitrile butadiene styrene (ABS), acrylonitrile styrene acrylate (ASA), ABS-PC, PET-PC, PBT-PC, PC-PBT and/or ASA-PC and/or copolymers or mixtures thereof. It is also possible for the plastic material also to have inorganic or organic fillers, preferably SiO₂, Al₂O₃, TiO₂, clay minerals, silicates, zeolites, glass fibers, carbon fibers, glass beads, organic fibers or mixtures thereof. Here, the fillers are added in particular to the plastic material in order to further increase the stability of the injection-molded part, in particular the injection-molded body. Further, these fillers can reduce the proportion of polymeric materials and thus lower the production costs and/or the weight of the injection-molded part, in particular the injection-molded body. It is also possible for the plastic material also to have inorganic or organic auxiliary substances, which in particular improve the processability of the plastic material. Further, it is possible for the plastic material to be biodegradable and/or compostable. For example, the plastic material then comprises polylactide (PLA) or polylactic acid.

It is also preferably provided that the injection-molded part, in particular in the at least one first area, has a flat surface and/or a surface with at least one curvature about at least one axis. The surface can be formed as a single curvature. In the case of a single curvature, the curvature is effected about exactly one axis. However, the surface can also have a multiple curvature, wherein by multiple is meant at least two curvatures about one axis in each case. The surface has at least two axes, about which the curvatures run in each case. The direction of curvature and the radius of curvature can also be designed differently in each case. It is preferably provided that in the case of a multiple curvature the orientation of the at least two axes is identical.

By identical orientation is meant axes which are aligned parallel to each other. In the case of a multiple curvature with at least two axes the orientation of which is not identical, reference is made to skew axes or intersecting axes. A multiple curvature with non-identical axes is not provided for this label, as such a curvature causes stresses in at least two spatial directions, whereby parts of the transfer ply could possibly break out or detach.

As an example of a single curvature, a sheet of paper with the DIN A4 format can be used, which is held along its two short sides and is then bent once about an axis which is perpendicular to the long side and lies in the paper plane. A U-shaped curvature results here.

For example, the sheet of paper can also be bent about two axes which are perpendicular to the long side and lie in the paper plane. The sheet of paper is thus bent twice. A type of undulation results, which is composed of two U-shaped sections, wherein the openings thereof point in opposite directions. Reference is then made to a double curvature, wherein the axes of curvature have the same or identical orientation, in particular are arranged parallel to each other.

For example, a multiple curvature the axes of which do not have an identical orientation can denote a spherical surface.

In particular, it is provided that the curvature of the label is predefined by the suction tool and/or the injection-molding apparatus, in particular of the at least one first injection mold half and/or the at least one second injection mold half. This supports the transfer of the label from the suction tool to the injection-molding apparatus. During the transfer, it is preferably provided that the vacuum on the suction tool disengages at the same time as the vacuum on the injection-molding apparatus develops. It is thereby ensured that no positioning inaccuracies occur. It can also be provided that the at least one label is pre-molded before being laid in the injection-molding apparatus.

For example, blind holes, ridges, grooves, circumferential edges or other structures with small radii and/or high depth-to-width ratios can be decorated.

The curvatures can preferably have a surface area in the range of from 0% to 85%, preferably from 0% to 70%, particularly preferably from 0% to 50%, relative to the entire surface area of the label.

It is also possible for the injection-molded part, in particular in the at least one first area, to have an edge radius and/or corner radius greater than 0.3 mm, in particular greater than 0.2 mm.

It is preferably provided that the injection-molded part has a decoration depth, in particular wherein the decoration depth corresponds to the smallest corner radius and/or edge radius present multiplied by a factor, wherein the factor lies in a range of from 0.75 to 1.25, preferably from 0.95 to 1.05.

Advantageous embodiment examples of the invention are described in the dependent claims.

Further embodiments of the invention are represented in the figures and described below. There are shown in:

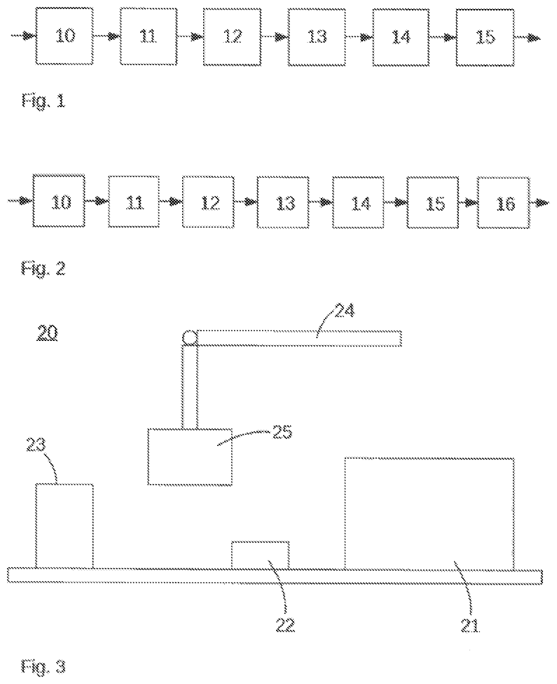

FIG. 1: a schematic representation of a method for decorating an injection-molded part

FIG. 2: a schematic representation of a method for decorating an injection-molded part

FIG. 3: a schematic representation of a device for decorating an injection-molded part

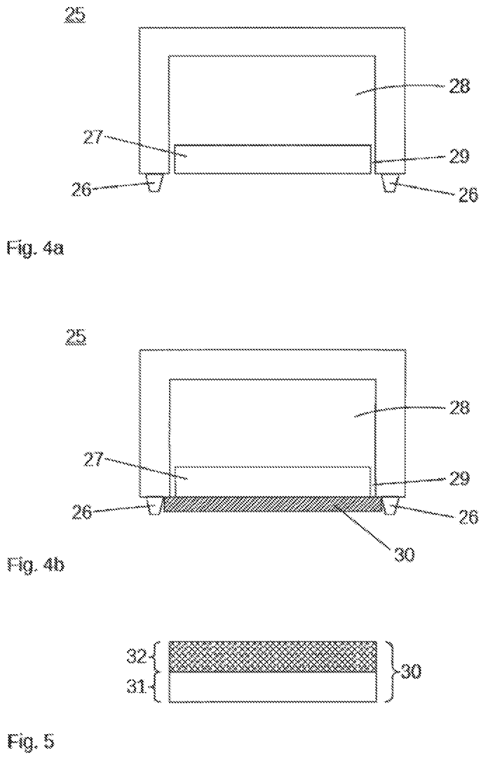

FIG. 4a: a schematic representation of a suction tool

FIG. 4b: a schematic representation of a suction tool with label picked up

FIG. 5: a schematic representation of a transfer film or a label

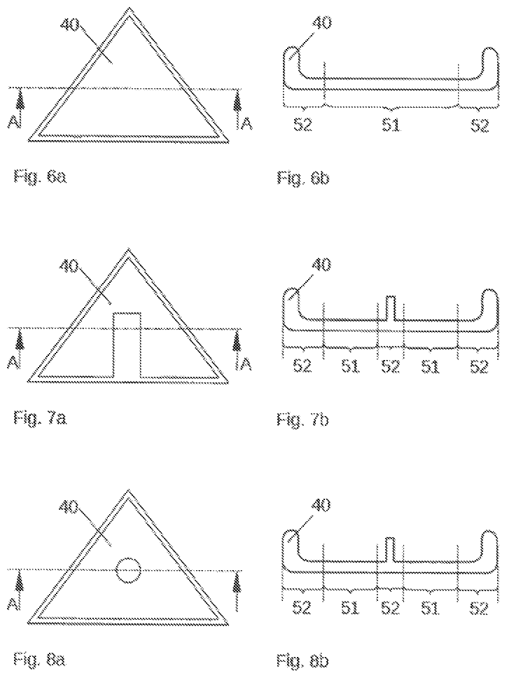

FIG. 6a: a schematic representation of an injection-molded part in top view

FIG. 6b: a schematic representation of an injection-molded part in sectional view

FIG. 7a: a schematic representation of an injection-molded part in top view

FIG. 7b: a schematic representation of an injection-molded part in sectional view

FIG. 8a: a schematic representation of an injection-molded part in top view

FIG. 8b: a schematic representation of an injection-molded part in sectional view

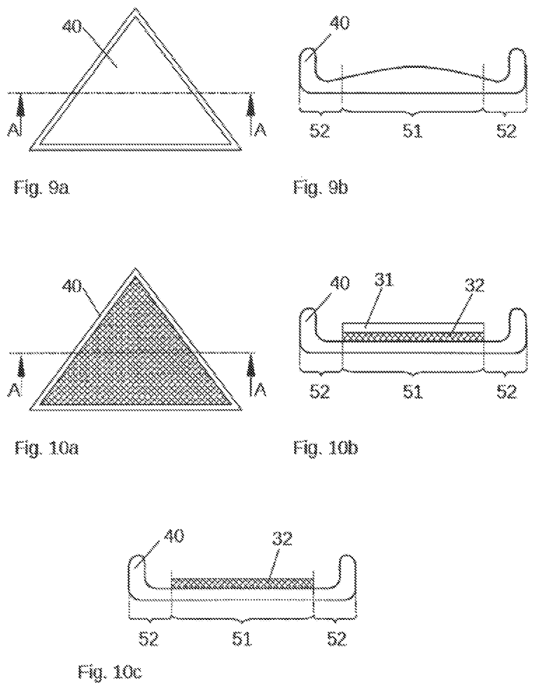

FIG. 9a: a schematic representation of an injection-molded part in top view

FIG. 9b: a schematic representation of an injection-molded part in sectional view

FIG. 10a: a schematic representation of an injection-molded part in top view

FIG. 10b: a schematic representation of an injection-molded part in sectional view

FIG. 10c: a schematic representation of an injection-molded part in sectional view

In the following, the invention is explained by way of example with reference to several embodiment examples utilizing the attached drawings. The embodiment examples shown are therefore not to be understood as limitative.

FIG. 1 shows a schematic representation of a method for decorating an injection-molded part 40, comprising the following steps, which are carried out in particular in the following order:
a) providing a transfer film in the form of a roll 10
b) cutting the transfer film to size to form at least one label 30, 11
c) laying the at least one label 30 in an injection-molding apparatus 21 by means of a robot arm 24, 12
d) closing the injection-molding apparatus 21, 13
e) back-injection molding the at least one label 30 by means of an injection-molding compound 14
f) opening the injection-molding apparatus 21 and removing the injection-molded part 40, 15

It is possible for the cutting to size of the transfer film to form at least one label 30, 11, in particular in step b), to be effected by means of steel strip cutting and/or punching and/or cutting plotters and/or lasers.

For example, it is provided that the cutting to size of the transfer film 11, in particular in step b), to form at least one label 30 is effected registration-accurately and/or register-accurately, in particular wherein at least one registration mark and/or at least one register mark and/or at least one motif is detected by means of at least one sensor, preferably optical sensor and/or camera.

In particular, an accuracy in the range of from −0.1 mm to 0.1 mm, preferably from −0.05 mm to 0.05 mm, is thus achieved during the cutting to size of the at least one label 30, 11, preferably in step b).

It is preferably provided that the following step is further carried out after the cutting to size 11, in particular before the laying-in 12:
placing the at least one label 30 in at least one pre-centering device 22, in particular in at least one magazine 23 for several labels 30 and/or at least in a specific depositing location for an individual label 30.

The pre-centering device 22 guarantees that the at least one label 30 is always gripped or picked up in a positionally accurate manner and is laid or placed in the injection-molding apparatus 21 in a positionally accurate manner. The labels can for example be present as a stack in the magazine, wherein the labels are arranged one on top of another and thus form a stack.

Further, it is preferably provided that the following step is further carried out after the cutting to size 11, preferably after the placing of the at least one label 30 in at least one pre-centering device 22, particularly preferably before the laying-in 12:
picking up the at least one label 30 from the at least one pre-centering device 22 by means of a robot arm 24, in particular a suction tool 25, wherein the at least one label 30 is first picked up, is deposited in the at least one pre-centering device 22 again and once more picked up by the robot arm 24, in particular the suction tool 25.

It is also possible for the laying-in of the at least one label 30, 12, in particular in step c), to be effected in a positionally accurate manner, in particular wherein the centering device 26, preferably the at least two positioning elements, produces or produce a positive-locking join to the injection-molding apparatus 21, preferably at least one first injection mold half, particularly preferably at least one rigid or nozzle-side and/or immovable injection mold half.

In particular, the laying-in of the at least one label 30, 12, preferably in step c), is effected with an accuracy in the range of from −0.2 mm to 0.2 mm, preferably from −0.1 mm to 0.1 mm.

Furthermore, it is preferred that the injection-molding apparatus 21 holds the laid-in at least one label 30 in step c), preferably in step d) and/or step e), by means of vacuum in at least one first injection mold half, in particular the at least one rigid or nozzle-side injection mold half.

It is also possible for the injection-molding compound, in particular in step e), to be injected by means of injection pressure in the direction of at least one second injection mold half, in particular the movable injection mold half, in particular with the result that the at least one label 30 is pressed against the at least one second injection mold half.

In particular, it is provided that a join, in particular a firm join, between the injection-molding compound and the at least one label 30 is produced in step e).

The back-injection molding of the at least one label 30 in step e) is preferably effected with a temperature in the range between 200° C. and 320° C., preferably between 240° C. and 290° C., further preferably between 240° C. and 270° C.

The back-injection molding of the at least one label 30 in step e) is advantageously effected with a pressure in the range between 10 bar and 2800 bar, preferably between 500 bar and 2500 bar, further preferably between 500 bar and 2000 bar.

It is also possible for the injection-molding apparatus 21 to be opened in step f) after a predetermined time, in particular a predetermined cooling time. The delayed opening of the injection-molding apparatus 21 ensures that the injection-molding compound is sufficiently cooled and thus cured. This also guarantees a secure or firm join of the injection-molded part 40 to the label 30, in particular the transfer ply 32.

Substantially the same method as in FIG. 1 is schematically represented in FIG. 2, but with the difference that the following step is further carried out, preferably after the injection-molding apparatus 21 15 has been opened, in particular after step f):
peeling the carrier film 31 off the injection-molded part 40, 16 in order to provide a decorated injection-molded part 40.

Through the peeling-off of the carrier film 31, the transfer ply 32 of the label 30 is exposed and thus becomes visible. The carrier film 31 acts as protection for the transfer ply 32 from external environmental influences, for example mechanical, chemical and/or physical stresses, in particular after the injection-molding apparatus 21 has been opened. Thus, it is conceivable for example that the injection-molded part 40 is stored temporarily and/or transported after removal from the injection-molding apparatus 21. The carrier film 31 can then be taken off only shortly before installation of the injection-molded part 40 and/or use of the injection-molded part 40. It is thus ensured that the transfer ply 32, which preferably generates an optical effect and/or a functional coating, remains undamaged.

FIG. 3 shows an example design of a device 20 for decorating an injection-molded part 40. In this design, the device 20 has a magazine 23 for collecting one or more labels 30, a pre-centering device 22, an injection-molding apparatus 21 and a robot arm 24 with a suction tool 25 located thereon.

In an alternative design, however, it is also possible for the device 20 to have at least one cutting device for cutting at least one label 30 to size out of a transfer film, at least one robot arm 24 and at least one injection-molding apparatus 21, wherein the at least one label 30 is laid in the injection-molding apparatus 21 by means of the at least one robot arm 24 and the at least one label 30 is joined to an injection-molding compound in the injection-molding apparatus 21 in order to produce an injection-molded part 40.

It is possible for the cut-to-size labels 30 to be collected in a magazine 23. A label 30 is gripped and removed by means of a robot arm 24 with suction tool 25. It can be possible for the magazine 23 already to act as a pre-centering device 22. First of all, a label 30 is picked up with the suction tool 25 and placed in a corner of the magazine 23 and temporarily deposited. After a predetermined residence time, preferably of from 0.5 s to 1.0 s, the label 30 is gripped by the suction tool 25 again. Because the robot arm 24 always arrives at the same position with respect to the magazine 23, it can thus be guaranteed that the labels 30 are always picked up in the same position. In the case where the magazine 23 does not act as a pre-centering device 22, the label 30 is removed from the magazine 23 by means of the suction tool 25 and laid in the pre-centering device 22. After a predetermined residence time, preferably of from 0.5 s to 1.0 s, the label 30 is then removed from the pre-centering device 22 again in a positionally accurate manner by means of the suction tool 25 and can be laid in the injection-molding apparatus 21. However, it can also be possible for both the magazine 23 and the pre-centering device 22 to function to center the label 30.

The at least one injection-molding apparatus 21 preferably has at least one first injection mold half, in particular rigid or nozzle-side and/or immovable injection mold half, and at least one second injection mold half, in particular movable injection mold half.

It is also possible for the at least one injection-molding apparatus 21, in particular the at least one first injection mold half, to have a negative mold of the at least one centering device 26, with the result that a positive-locking join to the at least one centering device 26 is effected and a positionally accurate laying-in of the at least one label 30 is made possible, in particular wherein an accuracy in the range of from −0.2 mm to 0.2 mm, preferably from −0.1 mm to 0.1 mm, is achieved.

It is preferably provided that the at least one injection-molding apparatus 21, in particular the at least one first injection mold half, has at least one vacuum chamber 28, which fixes the at least one label 30 after it has been laid in the injection-molding apparatus 21.

For example, it is provided that the at least one cutting device comprises at least one punch and/or a cutting plotter and/or a laser. In particular when a cutting plotter and/or a laser and/or a punch is used, the at least one label 30 can be cut to size with an accuracy in the range of from −0.1 mm to 0.1 mm, preferably from −0.05 mm to 0.05 mm.

It is preferably provided that the at least one cutting device has at least one sensor, preferably an optical sensor or a camera, which detects an at least one registration mark and/or register mark printed on the transfer film, with the result that the cutting to size of the transfer film to form at least one label 30 is effected in a positionally accurate manner.

It is also possible for the at least one cutting device to cut the at least one label 30 to size with an accuracy in the range of from −0.1 mm to 0.1 mm, preferably from −0.05 mm to 0.05 mm.

It is also preferably provided that the robot arm 24 can be moved between the individual stations of the device 20, in particular the pre-centering device 22 and/or the magazine 23 and/or the cutting device and/or the injection-molding apparatus 21, with the result that the process sequence proceeds in a fully automated manner. The efficiency can thereby be increased, and thus the manufacturing costs can also be reduced.

It is preferably possible for the at least one robot arm 24 to have at least one suction tool 25 for gripping or picking up the at least one label 30, in particular by means of vacuum. The gripping by means of vacuum guarantees that the transfer film does not kink and/or bend. In particular the transfer ply 32 of the transfer film is to be treated carefully, as constituents, in particular varnish constituents and/or varnish layers, can break off and/or detach if the transfer ply 32 curves and/or bends too much. Through the gripping of the label 30 by means of vacuum, such a breaking off and/or detaching of the varnish constituents and/or varnish layers is avoided.

FIG. 4a shows a suction tool 25 in a schematic representation. In this embodiment, the suction tool 25 has a retaining plate 27, a vacuum chamber 28, a vacuum zone 29 and two conical positioning elements, wherein the two conical positioning elements act as centering device 26.

For example, it is possible for the suction tool 25 to have a retaining plate 27, the surface of which substantially corresponds to at least one surface of the at least one first injection mold half and/or the at least one second injection mold half and/or the injection-molded part 40. The advantage thereby results that when picked up by means of the suction tool 25 the label 30 is already in the form in which it is applied to the injection-molded part 40 after the back-injection molding. The mechanical stress on the label 30 during the back-injection molding is thereby reduced, and thus also the danger of a possible breaking off or detaching of varnish layers of the transfer ply 32.

It is preferably provided that the at least one suction tool 25 has at least one vacuum zone 29, in particular circumferential vacuum zone 29, preferably wherein the vacuum zone 29 is designed in the form of a slit and/or gap running around the retaining plate 27 and/or wherein several slits and/or several gaps are arranged in the retaining plate 27. It is provided in particular that the vacuum zone 29 is arranged such that the gaps and/or slits are distributed over the entire surface area of the retaining plate 27. A possibly uniform pick-up of the label 30 is thereby guaranteed. This means that the label 30 does not bulge and/or undulate in an undefined manner. In this case, undefined means not following the contour or surface of the retaining plate 27.

The vacuum zone 29, in particular the slit and/or gap, advantageously has a width and/or depth in the range of from 0.02 mm to 0.2 mm, preferably from 0.05 mm to 0.1 mm.

It is also possible for the vacuum zone 29 to correspond to the contour of the label 30 and/or wherein the dimensions of the vacuum zone 29, in particular the width and length of the vacuum zone, are smaller than the label 30, preferably 0.5 mm to 2.0 mm smaller, particularly preferably 0.5 mm to 1.5 mm smaller.

It is preferably provided that the at least one suction tool 25, in particular the at least one retaining plate 27, has a bend-proof material, in particular aluminum and/or steel and/or magnesium and/or ceramic and/or fiber-reinforced plastic. The bend-proof material ensures that the label 30 always adapts to the contour of the retaining plate 27.

Furthermore, it is also possible for the at least one suction tool 25 to have at least one centering device 26, in particular wherein the centering device 26 has at least two positioning elements, in particular conical positioning elements or truncated cones, and/or at least one flat centering device, which center the at least one label 30 mechanically.

In FIG. 4b it is represented by way of example how the suction tool 25 picks up a label 30. Through the conical design of the positioning elements or of the centering device 26, the label 30 is automatically centered mechanically when picked up. Through the generated negative pressure or vacuum of the vacuum chamber 28, the label 30 is held against the retaining plate 27 following the contours or following the surface. It is provided in particular that the label 30 does not alter its position during the entire holding process. Through the vacuum chamber 28 and its vacuum zones 29, the label 30 is picked up and held as gently as possible, with the result that an undesired bending and/or undulation and/or an undesired kinking is avoided.

The centering device 26 is preferably designed such that it can form a positive-locking join to a negative mold of the injection-molding apparatus 21, with the result that a positionally accurate transfer from suction tool 25 to the injection-molding apparatus 21 is effected.

FIG. 5 shows a schematic representation of a label 30 and/or of a transfer film in side view, with the result that the layer structure thereof can be seen. The transfer film, in particular the label 30, preferably has at least one carrier film 31 and at least one transfer ply 32.

In an alternative design, it can also be provided that at least one detachment layer is arranged between the at least one carrier film 31 and the at least one transfer ply 32. The at least one detachment layer is preferably a polymeric detachment layer, which has a detachment behavior that is better than and/or different from conventional carrier films. Such detachment layers are irreversibly joined to the carrier film 31 and a transfer ply 32 is arranged on the detachment layer. The transfer ply 32 can in particular be more easily detached from the carrier film 31 with a polymeric detachment layer, with the result that a higher-quality decoration of the injection-molded part 40 is achieved.

In particular, the at least one detachment layer has a layer thickness smaller than 1 μm, in particular smaller than 0.5 μm.

It is also possible for the at least one detachment layer to comprise at least one material or combination of materials selected from: wax, carnauba wax, montanic acid ester, polyethylene wax, polyamide wax, PTFE wax, silicone, melamine formaldehyde resin.

Further, it is preferably provided that the at least one transfer ply 32 has at least one layer or a combination of layers selected from: adhesive layer, detachment layer, decorative layer, metal layer, semiconductor layer, carbon black layer, adhesion-promoting layer, primer layer, color layer, protective layer, functional layer.

Preferably, it is also possible for the at least one carrier film 31 to comprise a material or a combination of materials selected from: PET, PMMA, PC, PE, PVC, ABS, PU, PBS, TPU, PP, PLA, PEF and/or PAN.

It is also provided that the transfer film, in particular the at least one carrier film 31 and/or the at least one transfer ply 32, is biodegradable and/or compostable. Biodegradable means here that a material breaks down into water and/or carbon dioxide and/or biomass to the extent of more than 90%, in particular to the extent of more than 95%, after a predefined time under defined temperature, air and moisture conditions in the presence of microorganisms or fungi. Biodegradable and/or compostable materials preferably comprise a material and/or a combination of materials selected from: starch, starch derivatives, cellulose, cellulose derivatives, lignin, polylactic acid (PLA), polyhydroxy fatty acids (PHB and/or PHV), chitin, chitosan, proteins, casein, gelatin, degradable polyester (PE).

Preferably, it is also possible for at least one registration mark and/or at least one register mark and/or at least one motif, which is detectable by means of at least one sensor, in particular optical sensor and/or camera, to be applied to the transfer film, in particular to the at least one label 30, in particular to be applied by means of digital printing and/or inkjet printing and/or pad printing.

Example representations of an injection-molded part 40 are represented in FIGS. 6a to 10c, wherein the injection-molded part 40 has a triangle in outline, which is formed substantially cup-shaped, i.e. has a rim. FIGS. 6a, 7a, 8a, 9a and 10a always show the injection-molded part 40 in top view, whereas in FIGS. 6b, 7b, 8b, 9b, 10b and 10c in each case a sectional view of the injection-molded part 40 is represented. The geometries of the injection-molded part 40 shown in FIGS. 6a to 10c are only to be understood by way of example. A wide variety of geometric designs of the injection-molded part 40 are provided. Thus, the injection-molded part can for example be a component part, in particular a vehicle part, a housing part, a cockpit component and/or a body component and/or a shell and/or the like.

For example, it is provided that the injection-molded part 40 has at least one injection-molded body and a label 30, in particular a transfer ply 32, joined to the at least one injection-molded body.

The injection-molded part 40 shown in FIGS. 6a and 6b has a first area 51 and a second area 52. It is preferably provided that the label 30, in particular the transfer ply 32, is at least partially present in the first area 51, but is not present in the second area 52. Various decorations can thus be realized, which produce a particularly high-quality optical impression and/or provide a particularly high-quality functional coating.

The injection-molded part 40 from FIGS. 7a and 7b has a bar which extends from the outer edge of the injection-molded part 40 into the interior. It follows from FIG. 7b that the injection-molded part 40 has three second areas 52 and two first areas 51. The bar is preferably located completely in a second area 52 and is therefore not decorated. However, it is possible for both first areas 51 to be decorated with the label 30.

A further design of the injection-molded part 40 is represented in FIGS. 8a and 8b, wherein a cylinder is arranged in the center of the injection-molded part 40, which is preferably not decorated. The cylinder is therefore arranged completely in a second area 52.

The injection-molded parts 40 shown in FIGS. 6a to 8b have substantially a flat surface, which is decorated. FIGS. 9a and 9b show an injection-molded part 40 with a bulging or curved surface.

It is preferably provided that the injection-molded part 40, in particular in the at least one first area 51, has a flat surface and/or a surface with at least one curvature about at least one axis.

It is also possible for the injection-molded part 40, in particular in the at least one first area 51, to have an edge radius and/or corner radius greater than 0.3 mm, in particular greater than 0.2 mm.

It is advantageously provided that the injection-molded part 40 has a decoration depth, in particular wherein the decoration depth corresponds to the smallest corner radius and/or edge radius present multiplied by a factor, wherein the factor lies in a range of from 0.75 to 1.25, preferably from 0.95 to 1.05.

FIGS. 10a, 10b and 10c show a decorated injection-molded part 40, wherein the injection-molded part 40 is not represented to scale. In FIG. 10b the label 30 is deposited over the whole surface completely on a surface of the injection-molded part 40 in at least one first area 51. The label 30 comprises at least one transfer ply 32, which is preferably firmly joined to the injection-molded part 40, and a carrier film 31. The carrier film 31 acts in particular as protection for the transfer ply 32, preferably when the injection-molded part 40 is removed from the injection-molding apparatus 21. The carrier film 31 thus protects the sensitive transfer ply 32 from mechanical and/or chemical and/or physical environmental influences. A decorated injection-molded part 40 is represented in FIG. 10c, wherein the carrier film 31 has been detached, thus only the transfer ply 32 is still present. The carrier film 31 can preferably be peeled off by hand and/or robot and/or a peeling-off device.

### LIST OF REFERENCE NUMBERS

10 providing a transfer film in the form of a roll
11 cutting the transfer film to size to form at least one label
12 laying the at least one label in an injection-molding apparatus
13 closing the injection-molding apparatus
14 back-injection molding the at least one label by means of an injection-molding compound
15 opening the injection-molding apparatus and removing the injection-molded part
16 peeling the carrier film off the injection-molded part
20 device
21 injection-molding apparatus
22 pre-centering device
23 magazine
24 robot arm
25 suction tool
26 centering device
27 retaining plate
28 vacuum chamber
29 vacuum zone
30 label
31 carrier film
32 transfer ply
40 injection-molded part
51 first area
52 second area

1. A method for decorating an injection-molded part comprising the following steps:
a) providing a transfer film in the form of a roll
b) cutting the transfer film to size to form at least one label
c) laying the at least one label in an injection-molding apparatus by means of a robot arm
d) closing the injection-molding apparatus
e) back-injection molding the at least one label by means of an injection-molding compound
f) opening the injection-molding apparatus and removing the injection-molded part

2. The method according to claim 1, wherein
the transfer film has at least one carrier film and at least one transfer ply.

3. The method according to claim 2, wherein
at least one detachment layer is arranged between the at least one carrier film and the at least one transfer ply.

4. The method according to claim 2, wherein
the at least one transfer ply has at least one layer or a combination of layers selected from: adhesive layer, detachment layer, decorative layer, metal layer, semiconductor layer, carbon black layer, adhesion-promoting layer, primer layer, color layer, protective layer, functional layer.

5. (canceled)

6. The method according to claim 3, wherein
the at least one detachment layer has a layer thickness smaller than 1 μm.

7. The method according to claim 3, wherein
the at least one detachment layer comprises at least one material or a combination of materials selected from: wax, carnauba wax, montanic acid ester, polyethylene wax, polyamide wax, PTFE wax, silicone, melamine formaldehyde resin.

8. (canceled)

9. The method according to claim 1, wherein
at least one registration mark and/or at least one register mark and/or at least one motif, which is detectable by means of at least one sensor is applied to the transfer film.

10. The method according to claim 1, wherein
the at least one robot arm has at least one suction tool for gripping or picking up the at least one label by means of vacuum.

11. The method according to claim 10, wherein
the at least one suction tool has at least one centering device, and/or at least one flat centering device, which center the at least one label mechanically.

12. The method according to claim 1, wherein
the cutting to size of the transfer film to form at least one label in step b) is effected by means of steel strip cutting and/or punching and/or cutting plotters and/or lasers.

13. The method according to claim 1, wherein
the cutting to size of the transfer film to form at least one label in step b) is effected registration-accurately and/or register-accurately.

14. The method according to claim 1, wherein
an accuracy in the range of from −0.1 mm to 0.1 mm, is achieved in step b) during the cutting to size of the at least one label.

15. The method according to claim 1, wherein
the following step is further carried out after step b), b1) placing the at least one label in at least one pre-centering device and/or at least in a specific depositing location for an individual label.

16. The method according to claim 1, wherein
the following step is further carried out after step b),
b2) picking up the at least one label from the at least one pre-centering device by means of a robot arm, wherein the at least one label is first picked up, is deposited in the at least one pre-centering device again and once more picked up by the robot arm.

17. The method according to claim 1, wherein
the laying-in of the at least one label in step c) is effected in a positionally accurate manner.

18. The method according to claim 1, wherein
the laying-in of the at least one label in step c) is effected with an accuracy in the range of from −0.2 mm to 0.2 mm.

19. The method according to claim 1, wherein
the injection-molding apparatus holds the at least one laid-in label in step c), by means of vacuum in the at least one first injection mold half.

20. The method according to claim 1, wherein
the injection-molding compound in step e) is injected by means of injection pressure in the direction of the at least one second injection mold half.

21. The method according to claim 1, wherein
a join, between the injection-molding compound and the at least one label is produced in step e).

22. The method according to claim 1, wherein
the back-injection molding of the at least one label in step e) is effected with a temperature in the range between 200° C. and 320° C.

23. The method according to claim 1, wherein
the back-injection molding of the at least one label in step e) is effected with a pressure in the range between 10 bar and 2800 bar.

24. The method according to claim 1, wherein
the injection-molding apparatus is opened in step f) after a predetermined time.

25. The method according to claim 1, wherein
the following step is further carried out after step f):
g) peeling the carrier film off the injection molded part in order to provide a decorated injection-molded part.

26. A device for decorating an injection-molded part
the device comprising at least one cutting device for cutting at least one label to size out of a transfer film, at least one robot arm and at least one injection-molding apparatus, wherein the at least one label is laid in the injection-molding apparatus by means of the at least one robot arm and the at least one label is joined to an injection-molding compound in the injection-molding apparatus in order to produce an injection-molded part.

27. The device according to claim 26, wherein
the at least one injection-molding apparatus has at least one first injection mold half, and at least one second injection mold half.

28. The device according to claim 26, wherein
the at least one injection-molding apparatus has a negative mold of an at least one centering device, with the result that a positive-locking join to the at least one centering device is effected and a positionally accurate laying-in of the at least one label is made possible.

29. The device according to claim 26, wherein
the at least one injection-molding apparatus has at least one vacuum chamber, which fixes the at least one label after it has been laid in the injection-molding apparatus.

30-32. (canceled)

33. The device according to claim 26, wherein
the at least one robot arm has at least one suction tool for gripping or picking up the at least one label by means of vacuum.

34. The device according to claim 33, wherein
the at least one suction tool has a retaining plate, the surface of which substantially corresponds to at least one surface of the at least one first injection mold half and/or the at least one second injection mold half and/or the injection-molded part.

35. The device according to claim 33, wherein
the at least one suction tool has at least one vacuum zone and/or wherein several slits and/or several gaps are arranged in the retaining plate.

36. The device according to claim 35, wherein
the vacuum zone has a width and/or depth in the range of from 0.02 mm to 0.2 mm.

37. The device according to claim 35, wherein
the vacuum zone corresponds to the contour of the at least one label and/or wherein the dimensions of the vacuum zone are smaller than the at least one label.

38. (canceled)

39. The device according to claim 33, wherein
the at least one suction tool has at least one centering device and/or at least one flat centering device, which center the at least one label mechanically.

40. An injection-molded part comprising
at least one injection-molded body and at least one label joined to the at least one injection-molded body.

41. The injection-molded part according to claim 40, wherein
the at least one label is at least partially present in at least one first area and is not present in at least one second area.

42. The injection-molded part according to claim 40, wherein
the injection-molded part has a flat surface and/or a surface with at least one curvature about at least one axis.

43. The injection-molded part according to claim 40, wherein
the injection-molded part has an edge radius and/or corner radius greater than 0.3 mm.

44. The injection-molded part according to claim 40, wherein
the injection-molded part has a decoration depth present multiplied by a factor, wherein the factor lies in a range of from 0.75 to 1.25.

45. The device according to claim 35, wherein the vacuum zone is designed in the form of a slit and/or gap running around the retaining plate and/or wherein several slits and or several gaps are arranged in the retaining plate.
